(19) United States
(12) Patent Application Publication
(10) Pub. No.: US 2006/0027013 A1
(43) Pub. Date: Feb. 9, 2006

(54) Combustion pressure detecting apparatus

(75) Inventors: Takafumi Mizorogi, Saitama-ken (JP); Shin Mizota, Saitama-ken (JP); Katsunori Nakamura, Saitama-ken (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: HONDA MOTOR CO., LTD., Tokyo (JP)

(21) Appl. No.: 11/181,731

(22) Filed: Jul. 15, 2005

(30) Foreign Application Priority Data
Aug. 5, 2004 (JP) 229878/2004
Oct. 28, 2004 (JP) 314553/2004

(51) Int. Cl. G01L 23/22

(52) U.S. Cl. 73/35.12

(57) ABSTRACT

A combustion pressure detecting apparatus is provided for improving a combustion pressure detection accuracy. The combustion pressure detecting apparatus is mounted in a mounting hole of a cylinder head together with a combustion device for detecting the pressure within a combustion chamber as a combustion pressure. The combustion device may be one of an injector for injecting a fuel and a spark plug for igniting an air/fuel mixture within the combustion chamber. The combustion pressure detecting apparatus comprises an injector seat facing the combustion chamber and arranged in the mounting hole in a state in which a load from the combustion device is blocked, and a sensor element fixed between injector seat and the cylinder head by the injector seat for detecting a load transmitted thereto through the injector seat as a combustion pressure.

### BACKGROUND OF THE INVENTION

1. Field of the Invention

The present invention relates to a combustion pressure detecting apparatus mounted to an internal combustion engine for detecting the pressure within a combustion chamber.

2. Description of the Prior Art

A conventional combustion pressure detecting apparatus is known, for example, from one disclosed in Laid-open Japanese Patent Application No. 10-18898. This detecting apparatus is mounted to a direct injection type engine, and comprises an annular seat pressure sensor sandwiched between an injector mounted to a cylinder head of the engine and the cylinder head. The injector injects a combustion pumped by a fuel pump to a high pressure into the combustion chamber, and has an injection hole facing the combustion chamber through a hole of the cylinder head. The seat pressure sensor in turn comprises a piezo-electric sensor or the like, and outputs a detection signal in accordance with a load acting thereto. According to the detecting apparatus configured as described above, a load acting on the seat pressure sensor from the injector varies in response to displacements of the injector caused by the pressure within the combustion chamber (hereinafter called the “combustion pressure”). The seat pressure sensor detects variations in the load as variations in the combustion pressure to output a detection signal.

The combustion pressure detecting apparatus of Laid-open Japanese Patent Application No. 10-18898, however, has the following problems. Specifically, in this detecting apparatus, the load acting on the seat pressure sensor varies (hereinafter called the “fuel pressure variations”) due to the introduction of a high-pressure fuel into the injector, a reaction when the fuel is injected, and the like. Then, since the fuel pressure variations are transmitted from the injector to the seat pressure sensor, a combustion pressure detection accuracy is degraded as a result of the fuel pressure variations included in the combustion pressure detected by the seat pressure sensor.

Also, since the seat pressure sensor outputs the detection signal in accordance with a change in the load acting thereon, an initial load must be set to a proper value as a reference in a state where no combustion pressure is acting, in order to maintain the detection accuracy. However, since the injector can be removed, for example, for maintenance, or replaced, the initial load can deviate from the proper value when the injector is again mounted to the cylinder head, thus experiencing difficulties in maintaining the detection accuracy.

Another conventional combustion pressure detecting apparatus is known, for example, from Laid-open Japanese Patent Application No. 2002-168722. This detecting apparatus is fitted in a plug hole formed in a cylinder head together with a spark plug. The plug hole is arranged between an intake port and an exhaust port, extends in the vertical direction, and is formed with a mounting hole having a smaller diameter such that it is continuous to the bottom of the plug hole. The spark plug is mounted by screwing its mounting bracket into the mounting hole, with its lower end facing a combustion chamber.

An annular pressure sensor element is arranged on a step on the boundary between the plug hole and the mounting hole. Specifically, this pressure sensor element is sandwiched between a flange shaped sensor supporting member formed along the outer peripheral surface of the mounting bracket and the step. Also, a plug tube extends into the plug hole, and a groove is formed in the inner surface of the plug tube, extending in its lengthwise direction. A sensor output lead line, which is connected to the pressure sensor element, extends to the outside of the plug hole through the groove of the plug hole.

According to the detecting apparatus configured as described above, a load acting on the pressure sensor element through the spark plug varies in response to variations in the combustion pressure. The pressure sensor element detects the variations in the load as variations in the combustion pressure, and outputs a detection signal through the sensor output lead.

The combustion pressure detecting apparatus of Laid-open Japanese Patent Application No. 2002-168722, however, has the following problems. Specifically, since the sensor output lead line passes through the plug hole, its large length causes a degraded operability, for example, in the event of assembly and maintenance. Also, the cylinder head tends to be heated by heat generated from the combustion within the combustion chamber. Particularly, the plug hole is generally arranged at a position adjacent to an exhaust port through which high-temperature exhaust gases of the cylinder head pass, the plug hole tends to be affected by the heat of the exhaust gases. Then, since the sensor output lead line extends within such a plug hole along its lengthwise direction, a large percentage of the sensor output lead line is exposed to the high temperature and therefore tends to be affected by the heat, possibly resulting in a failure in accurately detecting the combustion pressure.

### SUMMARY OF THE INVENTION

The present invention has been made to solve the problems as mentioned above, and it is an object of the invention to provide a combustion pressure detecting apparatus which is capable of improving the accuracy of detecting a combustion pressure.

To achieve the above object, according to a first aspect of the present invention, there is provided a combustion pressure detecting apparatus mounted in a mounting hole of a cylinder head together with a combustion device for detecting a pressure within a combustion chamber as a combustion pressure, wherein the combustion device is one of an injector for injecting a fuel or a spark plug for igniting an air/fuel mixture within the combustion chamber. The combustion pressure detecting apparatus is characterized by comprising a sensor fixing member facing the combustion chamber and arranged in the mounting hole in a state in which a load from the combustion device is blocked, and a sensor element fixed between the sensor fixing member and the cylinder head by the sensor fixing member for detecting a load transmitted thereto through the sensor fixing member as a combustion pressure.

According to this combustion pressure detecting apparatus, in the mounting hole of the cylinder head, there are mounted the sensor fixing member together with the combustion device which is one of the injector and spark plug. The sensor fixing member faces the combustion chamber, and the sensor element is fixed between the sensor fixing member and the cylinder head by the sensor fixing member. A combustion pressure is transmitted through such a sensor fixing member to the sensor element as a load, and the sensor element detects the load acting thereon as the combustion pressure.

Also, the sensor fixing member is disposed in a state in which a load from the combustion device is blocked, and the sensor element is fixed between the sensor fixing member and the cylinder head by such a sensor fixing member, so that even if a fuel pressure varies in the injector or the like, resulting variations in load will not affect the sensor element. In this way, fuel pressure variations can be eliminated from the detection signal, and the outputted detection signal only reflects the combustion pressure, thereby making it possible to improve the combustion pressure detection accuracy.

Also, since the transmission of a load from the combustion device is blocked, the initial load of the sensor element can be maintained, even if the injector is removed or replaced, for example, for purposes of maintenance, thus making it possible to maintain the combustion pressure detection accuracy. Generally, since the cylinder head is crowded with the intake port, the exhaust pipe and the like, there is not an available space wide enough to add a new component. On the other hand, the combustion pressure detecting apparatus is mounted using the mounting hole of the combustion device, which is an existing structure, the combustion pressure detecting apparatus can be made in compact as a whole without substantially requiring a change in the configuration and layout of the internal combustion engine.

Preferably, in the combustion pressure detecting apparatus described above, the sensor fixing member is arranged in the mounting hole with gaps being defined between the sensor fixing member and the combustion device.

According to this preferred embodiment of the combustion pressure detecting apparatus, the sensor fixing member is arranged in the mounting hole with the gaps being defined between the sensor fixing member and the combustion device. In other words, since the sensor fixing member is separated from the combustion device, it is possible to block a load resulting from variations in fuel pressure associated with the injector and the like without fail, so that a load associated with the combustion pressure alone acts on the sensor element, thus making it possible to improve the combustion pressure detecting accuracy.

Preferably, in the combustion pressure detecting apparatus described above, the sensor element is mounted in a sensor mounting recess formed in the cylinder head, and the combustion pressure detecting apparatus further comprises a supporting member arranged side by side with the sensor element in an axial direction of the mounting hole and sandwiched between the combustion device and the cylinder head for supporting the combustion device.

According to this preferred embodiment of the combustion pressure detecting apparatus, the cylinder head is formed with the sensor mounting recess, and the sensor element is fitted in the sensor mounting recess. Also, between the combustion device and the cylinder head, the supporting member is arranged side by side with the sensor element in the axial direction of the mounting hole, i.e., arranged to cover the sensor mounting recess. This supporting member is sandwiched between the combustion device and the cylinder head. In this way, the injector is supported by the cylinder head through the supporting member.

According to the configuration as described above, the components such as the sensor element, the supporting member and the like are arranged side by side in the axial direction of the mounting hole, so that the combustion pressure detecting apparatus can be reduced in size, particularly, in the size in a direction perpendicular to the axis of the mounting hole, without damaging the advantageous effects described above. Consequently, the combustion pressure detecting apparatus can be arranged without changing the existing configuration of the internal combustion engine. Also, the supporting member is sandwiched between the combustion device and the cylinder head, with no other components disposed between the supporting member and the combustion device, so that a large contact area can be ensured between the supporting member and the combustion device, and the combustion device can be mounted to the cylinder head in a stable state.

According to another aspect of the present invention, there is provided a combustion pressure detecting apparatus arranged in a cylinder head having an intake port and an exhaust port open to one side surface and the other side surface, respectively, together with a combustion device for detecting a pressure within a combustion chamber as a combustion pressure. the combustion device may be one of an injector for injecting a fuel and a spark plug for igniting an air/fuel mixture within the combustion chamber. The cylinder head is formed with a mounting hole at a position opposite to the exhaust port with respect to the intake port and below the intake port for mounting one of the injector and the spark plug. The combustion pressure detecting apparatus is characterized by comprising a sensor element mounted in the mounting hole for detecting the pressure within the combustion chamber, and a cable connected to the sensor element and extending in a direction opposite to the exhaust port for outputting a detection signal from the sensor element.

According to this combustion pressure detecting apparatus, in the mounting hole formed in the cylinder head, the sensor element is mounted together with the combustion device which is one of the injector and the spark plug. The mounting hole is formed on the opposite side to the exhaust pipe with respect to the intake port and at a position below the intake port, i.e., a position far from the exhaust port. Also, the cable connected to the sensor element extends in a direction opposite to the exhaust port. The sensor element detects the pressure within the combustion chamber as the combustion pressure, and a detection signal from the sensor element is outputted through the cable.

According to the configuration as described above, unlike the conventional plug hole, the mounting hole need not be extended vertically between the intake port and the exhaust port, so that the mounting hole can be made shorter than the conventional plug hole. Also, since the cable extends in the direction opposite to the exhaust port from such a mounting hole, the cable can be made shorter than the one which extends within the plug hole in the lengthwise direction as before. In this way, it is possible to facilitate the operability of the cable in the event of assembly, maintenance and the like. Also, since the mounting hole is formed at a position far from the exhaust port, with the cable extending from the mounting hole in the direction opposite to the exhaust port, the cable is hardly affected by the heat of exhausted gases. As a result, the cable is less susceptible to exposure to high temperatures and accordingly can extend its lifetime.

Preferably, in the combustion pressure detecting apparatus described above, the cylinder head is formed with a cable lead-out groove extending from the mounting hole in a direction opposite to the exhaust pipe and opening to an external surface of the cylinder head, and the cable extends through the cable lead-out groove to the outside of the cylinder head.

According to this preferred embodiment of the combustion pressure detecting apparatus, the cable of the sensor element extends to the outside of the cylinder head through the cable lead-out groove formed in the cylinder head. This cable lead-out groove extends from the mounting hole in the direction opposite to the exhaust port, and is open on the outer surface of the cylinder head. In this way, the cable can be stably led through the cable lead-out groove in the direction opposite to the exhaust port without a shift in position of the cable and the like. Thus, the cable can be stably maintained in a state where the cable is hardly affected by heat.

Preferably, in the combustion pressure detecting apparatus described above, the mounting hole comprises a supporting member for supporting the combustion device, and the supporting member is formed with a clearance section in a portion facing the cable lead-out groove for letting the cable pass.

According to this preferred embodiment of the combustion pressure detecting apparatus, the supporting member is provided in the mounting hole, such that the combustion device is mounted in the mounting hole as it is supported by the supporting member. Also, since the cable can freely pass through near the clearance section formed in a portion of the supporting member facing the cable lead-out groove, the cable is unlikely to come into contact with the supporting member or scrape with the supporting member, for example, even if the cable is routed in close proximity to the supporting member, so that the cable is less susceptible to damages. It is therefore possible to increase the degree of freedom in the positioning of the cable and to extend the lifetime of the cable.

Preferably, in the combustion pressure detecting apparatus described above, the cable lead-out groove extends from a lower end of the mounting hole.

According to this preferred embodiment of the combustion pressure detecting apparatus, the cable lead-out groove extends from the lower end of the mounting hole, and the cable extends through the cable lead-out groove to the outside of the cylinder head. In this way, since the cable lead-out groove is formed at a position far from the intake port as well, the cable can be readily arranged without being interfered with the exhaust port. Also, since a larger spacing can be ensured between the exhaust port and the cable lead-out groove, it is possible to further prevent the influence of heat from the exhaust port.

### BRIEF DESCRIPTION OF THE DRAWINGS

FIG. 1 is a partial cross-sectional view illustrating an engine when it is mounted with a combustion pressure detecting apparatus according to a first embodiment of the present invention and an injector;

FIG. 2 is a perspective view illustrating a cylinder head of the engine in FIG. 1 when it is mounted with the combustion pressure detecting apparatus and injectors;

FIG. 3 is a partially enlarged perspective view illustrating the injector and its surroundings in FIG. 1;

FIG. 4 is a partially enlarged perspective view illustrating the injector and its surroundings in FIG. 2;

FIG. 5 is a diagram schematically illustrating the combustion pressure detecting apparatus according to the first embodiment together with an injector; and

FIG. 6 is a diagram schematically illustrating a combustion pressure detecting apparatus according to a second embodiment together with an injector.

### DETAILED DESCRIPTION OF THE EMBODIMENTS

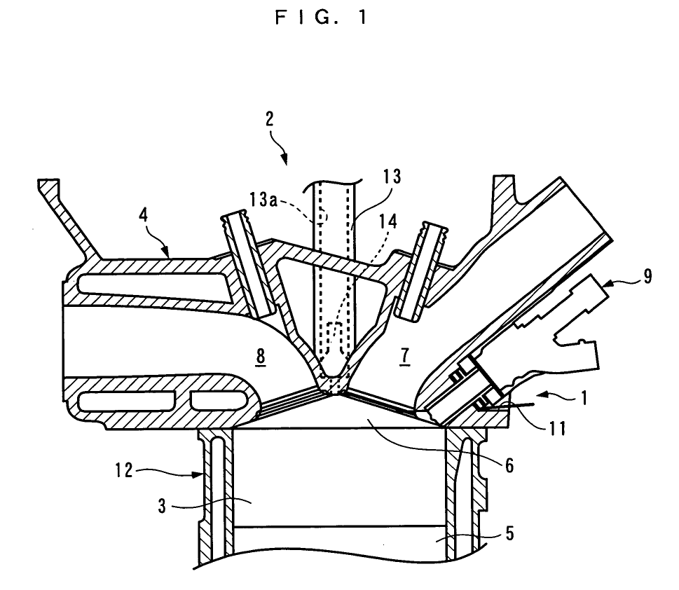

In the following, an embodiment of the present invention will be described in detail with reference to the accompanying drawings. FIG. 1 illustrates a combustion pressure detecting apparatus 1 according to a first embodiment of the present invention, and an internal combustion engine (hereinafter called the “engine”) 2 which is equipped with the combustion pressure detecting apparatus 1. This engine 2, which may be a straight four-cylinder direct injection engine, for example, equipped in a vehicle (not shown), has a cylinder head 4 and a cylinder block 12. Four cylinders 3 (one of which is shown in the figure) are arranged side by side in the cylinder block 12. Each cylinder head 4 is mounted on and securely joined to the top surface of the cylinder block 12. A combustion chamber 6 is defined between the cylinder head 4 and a piston 5 in each cylinder 3.

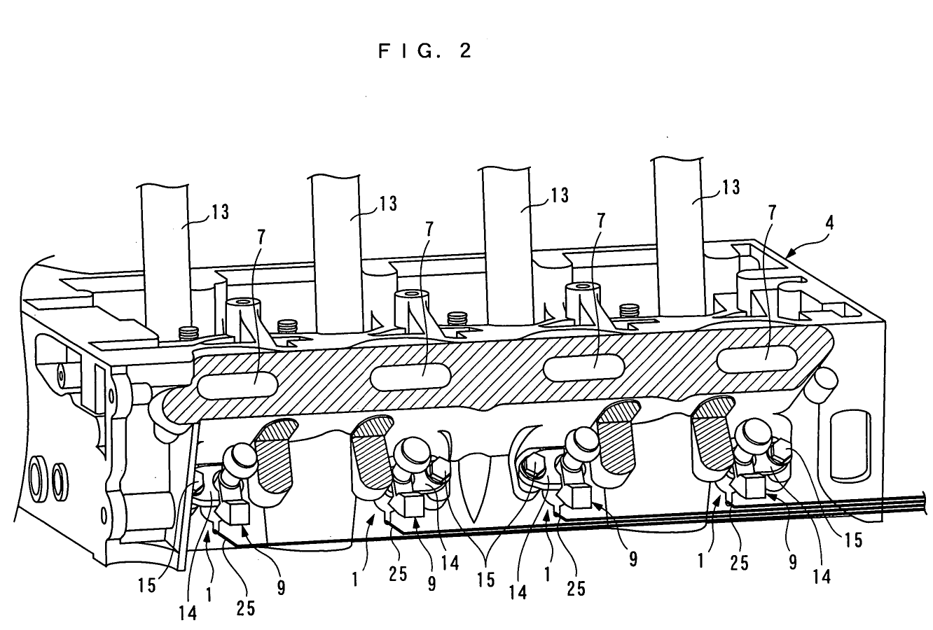

The cylinder head 4, which is made, for example, of an aluminum alloy in a complicated shape as illustrated in FIG. 2, is mounted with a variety of components. Each of the four cylinders 3 is formed with an intake port 7 and an exhaust port 8, which are open to one side surface and to the other side surface of the cylinder head 4, respectively, such that they are arranged side by side from left to right in FIG. 1. The intake port 7 and exhaust port 8 are provided with an intake valve and an exhaust valve (not shown), respectively. Also, a cylindrical spark plug mount 13, extending in the vertical direction, is disposed between the intake port 7 and the exhaust port 8. The spark plug mount 13 defines a plug hole 13a inside thereof, and a spark plug 14 is mounted to a plug mounting hole (not shown), formed in the bottom, for igniting an air/fuel mixture within the combustion chamber 6, with its lower end facing the combustion chamber 6. Above the cylinder head 4, an intake and an exhaust cam shaft (not shown) are disposed on one and the other sides of spark plug mount 13.

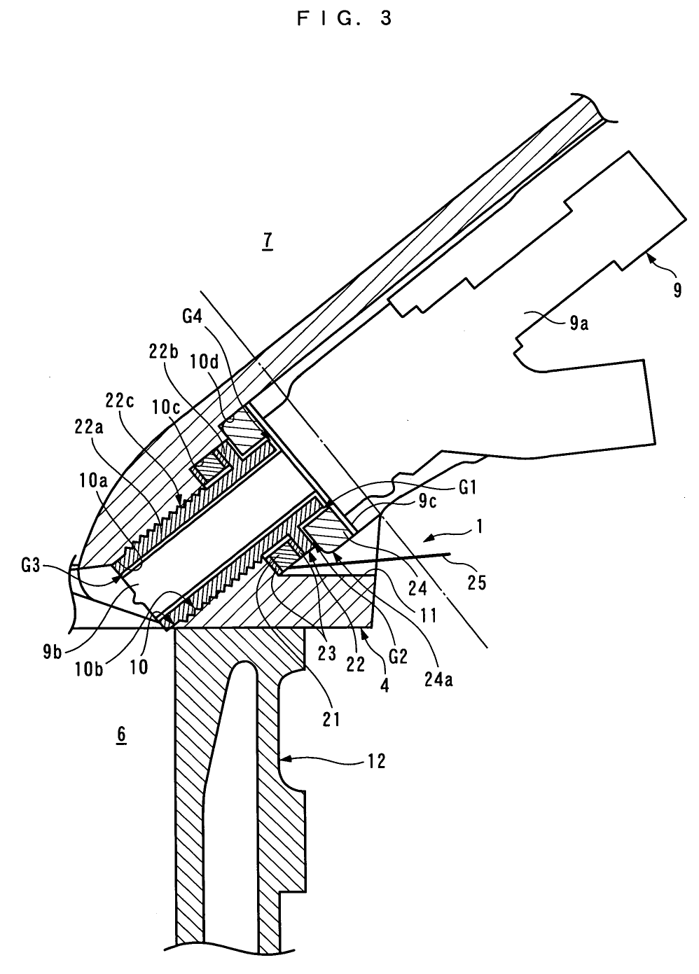

Also, as illustrated in FIG. 3, the cylinder head 4 is formed with a mounting hole 10 on the opposite side to the exhaust port 8 with respect to the intake port 8 and at a position immediately below the intake port 7. An injector 9 is mounted in this mounting hole 10 as a combustion device, and the combustion pressure detecting apparatus 1 is mounted together with the injector 9.

The mounting hole 10 obliquely extends through the cylinder head 4 (in a portion closer to the combustion chamber 6 from a one-dot chain line in FIG. 3), and comprises a seat receptacle 10a, a sensor mounting recess 10c, and a plate mounting recess 10d, which are concentric to one another, arranged in this order from the combustion chamber 6 in the axial direction of the mounting hole 10. The seat receptacle 10a occupies substantially one-half of the axial length of the mounting hole 10, and has a predetermined diameter, with threads 10b formed on its inner peripheral surface. The sensor mounting recess 10c has a diameter larger than that of the seat receptacle 10a and a predetermined depth (length in the axial direction), as will be later described. The plate mounting recess 10d has a diameter even larger than the sensor mounting recess 10c.

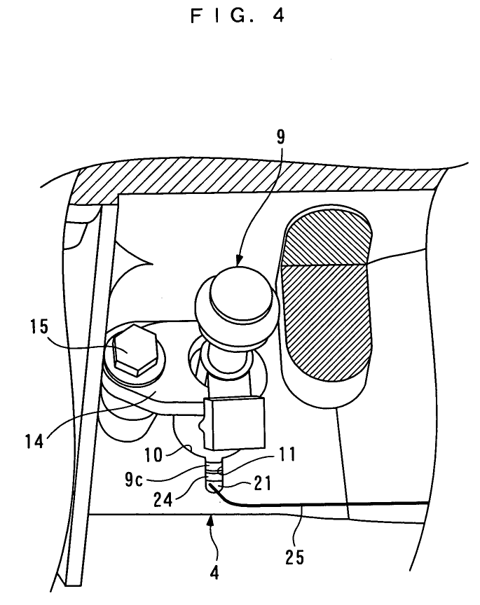

The cylinder head 4 is formed with a harness lead-out groove 11 (cable lead-out groove). This harness lead-out groove 11 is provided for drawing a harness 25 (cable) of a sensor element 21, later described, to the outside of the cylinder head 4. The harness lead-out groove 11 is positioned in a lower portion of the mounting hole 10, and extends from the lower end of the sensor mounting recess 10c to the right in FIG. 3, i.e., in a direction opposite to the exhaust port 8. While the mounting hole 10 obliquely extends, an arcuate bottom surface of the harness lead-out groove extends substantially in the horizontal direction. In this way, the depth (height from the bottom surface) of the harness lead-out groove 11 is higher as it is closer to the outside of the cylinder head, and is open on the outer surface of the cylinder head 4 in a U-shape, as illustrated in FIG. 4. Also, the harness lead-out groove 11 has a bottom surface, the horizontal length of which is shorter than the depth of the aforementioned plug hole 13a.

The combustion pressure detecting apparatus 1 comprises the sensor element 21, an injector seat 22 (sensor fixing member) for fixing the sensor element 21 thereon, an injector plate 24 (supporting member) for supporting the injector 9, and the like. The sensor element 21, which is formed in an annular shape and comprised, for example, of a piezo-electric element, outputs a detection signal in response to a load acting thereon. Also, annular gaskets 23 are laminated on and below the sensor element 21, and the sensor element 21 and gaskets 23 are fitted in the sensor mounting recess 10c.

The harness 25 is connected to the sensor element 21. The harness 25, which is provided for outputting the detection signal from the sensor element 21, passes substantially horizontally near the bottom of the aforementioned sensor lead-out groove 11, and extends to the outside of the cylinder head 4, opposite to the exhaust port 8. Four harnesses 25 in total, extracted to the outside of the cylinder head 4 from the respective sensor elements 21 extend substantially horizontally in the same direction along the side of the cylinder head 4. The four harnesses 25 are bundled to one another (in FIG. 4, they are shown with gaps between one another for convenience), and are connected to a controller (not shown) through a connector (not shown). The detection signals from the sensor elements 21 are outputted through the corresponding harnesses 25 and inputted to the controller.

The injector seat 22, which is made, for example, of a SUS material, comprises a cylindrical seat body 22a, and a flange 22b protruding from above the seat body 22a. The flange 22b is arranged at a position spaced by a predetermined distance toward the combustion chamber 6 from the upper end (opposite to the combustion engine 6) of the seat body 22a, and is formed in a discoidal shape. The seat body 22a is formed with threads 22c on the outer periphery thereof in a lower portion. The flange 22b has an external diameter which is set to be slightly smaller than the diameter of the aforementioned sensor mounting recess 10c. Also, the sum of the thicknesses of the flange 22b, the aforementioned sensor element 21 and the two gaskets 23 is set to be smaller than the depth of the sensor mounting recess 10c. Such the injector seat 22 is mounted to the cylinder head 4 by passing the seat body 22a through the annular sensor element 21 and the gaskets 23 from above, and screwing the threads 22c into the threads 10b of the seat receptacle 10a.

In this mounting state, the injector seat 22 presses the sensor element 21 downward through the gaskets 23 with substantially the entire surface of the flange 22b, and a resulting load acts on the sensor element 21 at all times. Specifically, the sensor element 21 is sandwiched between the cylinder head 4 and the flange 22b, and an initial load acting on the sensor element 21 is set by a fastening strength with which the injector seat 22 is screwed into the seat receptacle 10a for mounting. Also, the seat body 22a extends to the combustion chamber 6, with its lower end facing the combustion chamber 6. Further, from the dimensional relationship as described above, the upper surface of the flange 22b is slightly lower than the upper end of the sensor mounting recess 10c.

The injector plate 24 is mounted to the plate mounting recess 10d. This injector plate 24, is made, for example, of a SUS material, and is formed in the shape of a ring having a predetermined thickness. Also, the injector plate 24 has an outer diameter slightly smaller than the diameter of the aforementioned plate mounting recess 10, and has an inner diameter larger than the outer diameter of the seat body 22a. Also, at a corner between the outer peripheral surface and the bottom surface of the injector plate 24, a curve is formed along the circumferential direction, and the curved portion defines a clearance section 24a for letting the harness 25 pass nearby.

The injector plate 24 as described is mounted to the cylinder head 4 by fitting the same between the upper end of the seat body 22a and the peripheral wall of the plate mounting recess 10d. In this state, the injector plate 24 has its lower surface in abutment to the step on the boundary between the plate mounting recess 10d and the sensor mounting recess 10c, covers the sensor mounting recess 10c, is arranged side by side with the sensor element 21 in the axial direction, and overlaps in the axial direction. Also, from the aforementioned dimensional relationship, a gap G1 is formed in the radial direction between a portion of the injector seat 22 above the flange 22b and the injector plate 24, while a gap G2 is formed in the axial direction between the flange 22b and the injector plate 24. The injector seat 22 and the injector plate 24 are separated from each other. The upper end of the seat body 22a is positioned closer to the combustion chamber 6 than to the upper end of the injector plate 24. The clearance section 24a of the injector plate 24 faces the harness lead-out groove 1 from above.

The injector 9 is basically in a known structure. A fuel in a fuel tank (not shown) is pumped up to a high pressure by a fuel pomp under the control of the controller, and then sent to the injector 9 for injection into the combustion chamber 6 from the injector 9. The injector 9 comprises an injector body 9a, and a nozzle 9b extending from the injector body 9a and having a diameter slightly smaller than the inner diameter of the seat body 22a. Also, on the boundary between the injector body 9a and the nozzle 9b, a discoidal flange 9c is formed, with its outer diameter being set to substantially the same as the outer diameter of the aforementioned injector plate 24.

The nozzle 9b of the injector 9 is inserted into the injector seat 22, with its lower end facing the combustion chamber 6. The injector 9 is mounted to the cylinder head 4 by bringing the entire surface of the flange 9c into abutment to the injector plate 24, and screwing a bolt 15 into the cylinder head 4 through the mounting member 14 while the flange 9c is strongly pressed onto the injector plate 24. In other words, the injector plate 24 is sandwiched between the injector 9 and the cylinder head 4, and the injector 9 is supported by the injector late 24. Also, since the diameter of the nozzle 9b is slightly smaller than the inner diameter of the seat body 22a, a slight gap G3 is defined between the nozzle 9b and the seat body 22a in the radial direction. Further, as described above, the upper end of the seat body 22a is positioned closer to the combustion chamber 6 than to the injector plate 24, so that a gap G4 is formed between the injector 9 and an upper portion of the injector seat 22 in the axial direction. With the gaps G3, G4, the injector 9 is separated from the injector plate 24 when it is mounted.

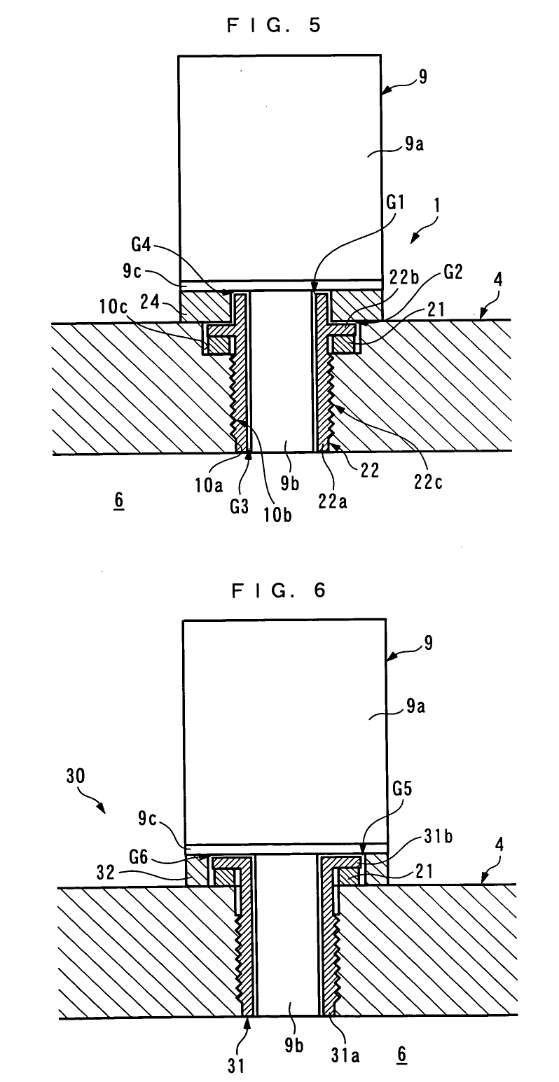

FIG. 5 schematically illustrates the aforementioned injector 9 and combustion pressure detecting apparatus 1. In the following, the operation of detecting a combustion pressure will be described with reference to FIG. 5. While the engine 2 is not in operation, the initial load caused by the injector seat 22 alone acts on the sensor element 21 because no combustion pressure is generated.

As the operation of the engine 2 is started, the combustion pressure is generated in association with intake, exhaustion, combustion and the like, and varies on a periodic basis. As described above, the injector seat 22 entirely displaces in the axial direction due to a varying pressure acting on the lower end of the injector seat 22 which faces the combustion chamber 6. In this way, when the combustion pressure increases, the flange 22b displaces in a direction opposite to the combustion chamber 6, resulting in a reduction in the load acting on the sensor element 21 and an expansion of the sensor element 21. Conversely, when the combustion pressure decreases, the flange 22b displaces toward the combustion chamber 6, resulting in an increase in the load acting on the sensor element 21, and a contraction of the sensor element 21. In this way, the sensor element 21 expands/contracts in response to a reduction/increase in the load acting thereon to output a detection signal indicative of a changing amount of the combustion pressure through the harness 25. Based on this detection signal, the combustion pressure is calculated in the controller.

As described above, according to the combustion pressure detecting apparatus 1 of this embodiment, the injector seat 22 defines the gaps G1-G4 between itself and the injector 9, and is arranged with a load from the injector 9 being blocked. The sensor element 21 is fixed between the cylinder head 4 and the injector 9 by the injector seat 22 which thus blocks the load from the injector 9. Therefore, even if the fuel pressure associated with the injector 9 varies, resulting variations in the load can be blocked without fail and will not affect the sensor 21. As a result, variations in the fuel pressure can be excluded from the detection signal, so that the outputted detection signal reflects only the combustion pressure, thus making it possible to improve the combustion pressure detection accuracy.

Also, since the transmission of the load from the injector 9 is blocked, the initial load of the sensor element 21 can be maintained, even if the injector 9 is removed or replaced, for example, for purposes of maintenance, thus making it possible to maintain the combustion pressure detection accuracy. Also, since the combustion pressure detecting apparatus 1 is mounted using the mounting hole 10 of the injector 9, which is an existing structure, the combustion pressure detecting apparatus 1 can be made in compact as a whole without substantially requiring a change in the configuration and layout of the engine 2. Particularly, since the sensor element 21 and the injector plate 24 are arranged side by side in the axial direction, the size can be reduced in the direction perpendicular to the axis of the mounting hole 10.

Further, the injector plate 24 is sandwiched between the injector 9 and the cylinder head 4, and no other component is present between the injector plate 24 and the injector 9, so that a large contact area can be ensured between the injector plate 24 and the injector 9, thus making it possible to mount the injector 9 to the cylinder head 4 in a stable state.

Also, since the length of the harness lead-out groove 11 for leading the harness 25 to the outside of the cylinder head 4 is shorter than the depth of the plug hole 13a, the harness 25 can be made shorter than that extending within the plug hole 13a in its lengthwise direction as before. With this structure, the operability of the harness 25 can be improved during the assembly, maintenance and the like of the engine 2. Also, the mounting hole 10 is defined at a position far from the exhaust port 8, and the harness 25 extends from the mounting hole 10 in the opposite direction to the exhaust port 8, so that the harness 25 is less likely to be affected by the heat of exhaust gases. As a result, the harness 25 is less susceptible to the exposure to high temperatures, thereby making it possible to extend its lifetime.

Also, the harness 25 of the sensor element 21 extends to the outside of the cylinder head 4 through the harness lead-out groove 11 formed in the cylinder head 4, and the harness lead-out groove 11 extends from the mounting hole 10 in the opposite direction to the exhaust port 8, and is open on the outer surface of the cylinder head 4. With this structure, the harness 25 can be lead through the harness lead-out groove 11 in the direction opposite to the exhaust port 8 in a stable manner without suffering from a shift in position of the harness 25, and the like. It is therefore possible to stably maintain the harness 25 in a state in which the harness 25 is hardly affected by the heat.

Also, the harness lead-out groove 11 formed for each of the cylinders 3 permits the four harnesses 25 to be led out to the outside of the cylinder head 4 on the same side, so that they can be readily handled, e.g., they can be bundled together.

Also, since the harness 25 can freely pass through near the clearance section 24a formed in a portion of the injector plate 24 which faces the harness lead-out groove 11, the harness 25 is unlikely to come into contact with the injector plate 24 or scrape with the injector plate 24, for example, even if the harness 25 is routed in close proximity to the injector plate 24. Even if the harness 25 comes into contact with the injector plate 24, the harness 25 is unlikely to suffer from damages because the clearance section 24a is formed with a curved corner and therefore has a curved shape. It is therefore possible to increase the degree of freedom in the positioning of the harness 25 and to extend the lifetime of the harness 25.

Also, the harness lead-out groove 11 extends from the lower end of the sensor mounting recess 10c, and is formed at a position far from the intake port 7 as well, so that the harness 25 can be readily routed without being interfered with by the intake port 7. Also, the foregoing positioning of the harness lead-out groove 11 ensures a larger spacing between the harness lead-out groove 11 and the exhaust port 8, thus making it possible to further prevent the influence of heat from the exhaust port 8 from exerting on the harness 25.

Further, since the length of the harness lead-out groove 11 is shorter, the state of the harness 25 placed therein can be visually confirmed in a simple manner, thus making it possible to facilitate the maintenance of the combustion pressure detecting apparatus.

FIG. 6 schematically illustrating a combustion pressure detecting apparatus according to a second embodiment of the present invention. This detecting apparatus 30 is similar in configuration to the combustion pressure detecting apparatus 1 of the first embodiment, so that common components are designated the same reference numerals, and the following description will be centered on different aspects from the first embodiment.

In the injector seat 22 in the first embodiment, the flange 22b is arranged at a position spaced by a predetermined distance from the upper end, whereas in an injector seat 31 (sensor fixing member) in the second embodiment, a flange 31b is arranged at the upper end of an injector seat body 31a, such that the sensor element 21 is sandwiched between the flange 31b and cylinder head 4.

Also, an injector plate 32 (supporting member) in the second embodiment is formed in an annular shape as well, and has its outer diameter substantially identical to that in the first embodiment, and its inner diameter larger than that in the first embodiment. With this modification, the space defined inside the injector plate 32 is expanded, such that the sensor element 21 is accommodated in this space. In other words, the injector plate 32 is formed to surround the sensor element 21, and a gap G5 is formed in the radial direction between the injector plate 32 and the sensor element 21. Also, the thickness of the injector plate 32 in the axial direction is set to a value larger than the sum of the thickness of the sensor element 21 and the thickness of the flange 31b in the axial direction, thereby permitting the formation of a gap G6 in the axial direction between the injector 9 and the injector seat 31 so that the injector 9 and the injector seat 31 are separated from each other. Consequently, variations in the combustion pressure are transmitted to the sensor element 21 only through the injector seat 31 as well in the combustion pressure detecting apparatus 30.

According to the combustion pressure detecting apparatus 30 as described above, since the transmission of a load from the injector 9 to the sensor element 21 is blocked by the gaps G5 and G6, as is the case in the combustion pressure detecting apparatus 1 of the first embodiment, the sensor element 21 will not be affected by variations in the fuel pressure associated with the injector 9, thus making it possible to improve the combustion pressure detection accuracy. Also, since the sensor element 21 is enclosed within the injector plate 32, the combustion pressure detecting apparatus can be made compact and simple in configuration as a whole.

It should be understood that the present invention is not limited to the embodiments described above, but can be practiced in a variety of implementations. For example, while the injector 9 is supported by the injector plate 24, 32, respectively, in the foregoing first and second embodiments, the present invention is not limited to this manner of supporting the injector 9. The injector plate may be omitted and replaced with another appropriate means as long as it can block the transmission of a load from the injector to the injector seat and support the injector in a stable state.

Also, in the first embodiment, the injector plate 24 is formed entirely with a curvature in the circumferential direction to form the clearance section 24a for the harness 25. However, the curvature may be formed, for example, only in a portion of the injector plate 24 which faces the harness lead-out groove 11, not limited to the foregoing. Further alternatively, instead of the formation of curvature, a groove or a notch, for example, may be formed. Also, while the foregoing embodiments have been described as an example of providing the combustion pressure detecting apparatus 1 together with the injector 9, the present invention is not limited to this combination. For example, a spark plug may be substituted for the injector 9, and arranged adjacent to the intake port 7 as a combustion device, and the combustion pressure detecting apparatus 1 may be disposed together with the spark plug.

Also, while the foregoing embodiments have been described in connection with the straight four-cylinder engine 2 to which the present invention is applied by way of example, the present invention can be applied to other types of engines having a single cylinder or a plurality of cylinders, not limited to the foregoing. Further, it goes without saying that the present invention is not limited to an engine equipped in a car but can be applied to a variety of internal combustion engines for industrial use, including an engine for vessel propeller such as an outboard engine which has a crank shaft arranged in the vertical direction. Otherwise, the present invention can be modified in detailed configuration as appropriate without departing from the spirit and scope of the invention as defined by the appended claims.

What is claimed is:

1. A combustion pressure detecting apparatus mounted in a mounting hole of a cylinder head together with a combustion device for detecting a pressure within a combustion chamber as a combustion pressure, wherein said combustion device is one of an injector for injecting a fuel or a spark plug for igniting an air/fuel mixture within said combustion chamber, said apparatus comprising:
a sensor fixing member facing said combustion chamber and arranged in said mounting hole in a state in which a load from said combustion device is blocked; and
a sensor element fixed between said sensor fixing member and said cylinder head by said sensor fixing member for detecting a load transmitted thereto through said sensor fixing member as a combustion pressure.

2. A combustion pressure detecting apparatus according to claim 1, wherein said sensor fixing member is arranged in said mounting hole with a gap being defined between said sensor fixing member and said combustion device.

3. A combustion pressure detecting apparatus according to claim 1, wherein;
said sensor element is mounted in a sensor mounting recess formed in said cylinder head; and
said combustion pressure detecting apparatus further comprises a supporting member arranged side by side with said sensor element in an axial direction of said mounting hole and sandwiched between said combustion device and said cylinder head for supporting said combustion device.

4. A combustion pressure detecting apparatus arranged in a cylinder head having an intake port and an exhaust port open to one side surface and the other side surface, respectively, together with a combustion device for detecting a pressure within a combustion chamber as a combustion pressure, said combustion device being one of an injector for injecting a fuel and a spark plug for igniting an air/fuel mixture within said combustion chamber, said cylinder head being formed with a mounting hole at a position opposite to said exhaust port with respect to said intake port and below said intake port for mounting one of said injector and said spark plug, said apparatus comprising:
a sensor element mounted in said mounting hole for detecting the pressure within said combustion chamber; and
a cable connected to said sensor element and extending in a direction opposite to said exhaust port for outputting a detection signal from said sensor element.

5. A combustion pressure detecting apparatus according to claim 4, wherein:
said cylinder head is formed with a cable lead-out groove extending from said mounting hole in a direction opposite to said exhaust pipe and opening to an external surface of said cylinder head, and said cable extends through said cable lead-out groove to the outside of said cylinder head.

6. A combustion pressure detecting apparatus according to claim 5, wherein said mounting hole comprises a supporting member for supporting said combustion device, and said supporting member is formed with a clearance section in a portion facing said cable lead-out groove for letting said cable pass.

7. A combustion pressure detecting apparatus according to claim 5, wherein said cable lead-out groove extends from a lower end of said mounting hole.
